(19) United States
(12) Patent Application Publication
(10) Pub. No.: US 2026/0105326 A1
(43) Pub. Date: Apr. 16, 2026

(54) LARGE LANGUAGE MODEL (LLM) POWERED DECISION TREES

(71) Applicant: Vela Partners Management, LLC, Oakland, CA (US)

(72) Inventors: Yigit Ihlamur, Oakland, CA (US); Sichao Xiong, Oxford (GB); Fuat Varol Alican, Istanbul (TR); Aaron Ontoyin Yin, Accra (GH)

(21) Appl. No.: 19/357,996

(22) Filed: Oct. 14, 2025

Related U.S. Application Data
(60) Provisional application No. 63/706,977, filed on Oct. 14, 2024.

(51) Int. Cl. G06N 5/022; G06N 5/04

(52) U.S. Cl. CPC G06N 5/022; G06N 5/04

(57) ABSTRACT

A system includes: a processor; and a memory storing instructions that, when executed by the processor, cause the processor to evaluate a decision tree including a plurality of nodes including: providing a first input data to an inference node of the decision tree, the inference node being associated with a prompt for instructing a large language model and a plurality of child nodes; supplying the prompt of the inference node and the first input data to a large language model to computing a node evaluation result of the inference node; selecting a child node from among the plurality of child nodes of the inference node based on the node evaluation result computed by the large language model; and generating a prediction of the decision tree in accordance with a leaf node selected from a plurality of leaf nodes of the decision tree.

### CROSS-REFERENCE TO RELATED APPLICATION(S)

This application claims the benefit of U.S. provisional patent application No. 63/706,977, filed in the United States Patent and Trademark Office on Oct. 14, 2024, the entire disclosure of which is incorporated by reference herein.

### FIELD

Aspects of embodiments of the present disclosure relate to the field of machine learning. In more detail, aspects of embodiments relate to decision trees that include large language models (LLMs).

### BACKGROUND

Machine learning models are trained based on input data to compute predictions regarding input data. For example, some machine learning models are used to classify input data (e.g., compute whether an input image depicts a landscape, people, plants, animals, household items, and the like) and some machine learning models (e.g., regression models) may be used to compute numerical values (e.g., predicting the selling price of a house based on features such as square footage, lot size, number of bedrooms, and the like).

A decision tree is one form of a machine learning model that includes a plurality of splitting rules associated with nodes of the tree. Starting at a root node of the decision tree, a splitting rule corresponding to the node is applied to the input data to select which of the child nodes to proceed to next. The process continues until it reaches a leaf node of the tree, where the leaf node may indicate a category or classification of the input data or which may include an expression for calculating a value based on the input data (e.g., regression function specific to the leaf).

A large language model (LLM) is a language model trained with self-supervised machine learning on a vast amount of text, designed for natural language processing tasks, especially language generation. An LLM may be implemented using a neural network, such as the transformer architecture. Some large language models are instruction-tuned (or instruction fine-tuned) such that they generate natural language responses to inputs that are also expressed using natural language (e.g., English language text).

The above information disclosed in this Background section is only for enhancement of understanding of the present disclosure, and therefore it may contain information that does not form the prior art that is already known to a person of ordinary skill in the art.

### SUMMARY

Aspects of embodiments of the present disclosure relate to a decision tree that includes one or more large language model (LLM)-powered inference nodes. In more detail, an LLM-powered inference node according to some embodiments of the present disclosure includes a prompt (e.g., a question) for invoking a large language model with respect to input data provided to the inference node, such that the LLM computes an answer to the prompt (or question) based on the provided input data.

Some aspects of embodiments of the present disclosure further relate to a method for automatically training an LLM-powered decision tree based on suppled training data and associated labels (e.g., expected outputs). Further embodiments of the present disclosure relate to providing user interfaces for subject matter experts to provide feedback and modifications to the LLM-powered decision tree, for embodiments of the present disclosure to automatically modify the LLM-powered decision tree based on the user feedback, and to display comparative results of the performance of the modified LLM-powered decision tree.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an example of a portion of a large language model (LLM) powered decision tree, according to one embodiment of the present disclosure.

FIG. 2 is a flowchart of a method for traversing an LLM-powered decision tree to evaluate the decision tree and to produce a prediction in accordance with input data, according to one embodiment of the present disclosure.

FIG. 3 is a flowchart of a method for training an LLM-powered decision tree, according to one embodiment of the present disclosure.

FIG. 4 is a flowchart of a method for modifying an LLM-powered decision tree, according to one embodiment of the present disclosure.

FIG. 5A is a screenshot of a portion of a user interface for modifying a node of an LLM-powered decision tree, according to one embodiment of the present disclosure.

FIG. 5B is a screenshot of a portion of a user interface for editing a question or prompt of an inference node of an LLM-powered decision tree, according to one embodiment of the present disclosure.

FIG. 5C is a screenshot of a portion of a user interface requesting that a user confirm the edits to the inference node, according to one embodiment of the present disclosure.

FIG. 5D is a screenshot of a portion of a user interface showing test results of the LLM-powered decision tree after applying the user's edits to the inference node, and offering options to revert the change, according to one embodiment of the present disclosure.

FIG. 6 is a block diagram illustrating a high-level network architecture of a computing system environment for operating a processing system according to embodiments of the present disclosure.

FIG. 7 is a block diagram illustrating a representative software architecture, which may be used in conjunction with various hardware architectures as described herein.

FIG. 8 is a block diagram illustrating components of a processing circuit or a processor, according to some example embodiments, configured to read instructions from a non-transitory computer-readable medium (e.g., a non-transitory machine-readable storage medium) and perform any one or more of the methods discussed herein.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

In the realm of machine-learning (ML), decision tree models are prized for their transparency, as they provide clear explanations for each decision, such that a human can easily follow and verify the steps taken to reach a final classification or prediction made by the decision tree model. However, decision trees often falter with non-linear data classifications, text-rich and multi-modal data inputs, which typically demand manual feature engineering to become usable (e.g., for humans to define specific signals or features to be extracted from the data inputs that are used to make decisions at each node of the tree); hence limiting their scope and applicability.

Conversely, machine learning models based on neural networks excel in handling complex, non-linear datasets but lack transparency, rendering their decision-making processes largely unexplainable. Human subject-matter experts are unable to understand why neural networks behave in various ways; hence, they cannot easily improve neural networks (e.g., to modify the neural network to reduce its error rate).

Recently, large language models (LLMs) have emerged as powerful tools that are capable of classification and decision-making. While LLMs offer significant advancements in reasoning, they alone are not sufficient for replacing traditional ML models in decision-making due to output variability and the risk of hallucinations (e.g., outputs that include factually incorrect, nonsensical, or unjustified statements) across runs. This inconsistency hinders their reliability as standalone solutions for mission critical use-cases that require stable and interpretable outputs with traceability. Some multi-modal LLMs are further configured and trained to accept multiple types of inputs, including text, images, audio, video, and structured data. The different types of inputs are transformed into a machine-readable format, such as where input text may be tokenized and where images may be converted into pixel grids.

Aspects of embodiments of the present disclosure integrate the reasoning, computer code writing, vision, and voice understanding capabilities of multi-modal LLMs with the robustness of traditional ML techniques in a decision tree structure. This approach evaluates natural language directly and leverages internal knowledge of the LLMs (e.g., from the training data of text) to propose enriched split conditions for the decision tree, thereby reducing the need for manual feature engineering. At the same time, the decision tree decomposes complex decisions into smaller, testable steps, and each step is selected by a deterministic impurity objective. This structure constrains hallucinations, preserves end-to-end transparency, maintains the familiar auditability of decision trees and involves non-technical domain experts in the modeling process while achieving higher accuracy than traditional ML models and LLMs. As such, embodiments of the present disclosure represent an improvement in the technological field of machine learning, providing accurate predictions while bringing explainability, traceability and flexibility for expert decision-makers (e.g., subject matter experts) to directly modify and improve the quality of the models.

Aspects of embodiments of the present disclosure relate to enhancing decision-tree algorithms by integrating LLM-based branches, creating a superior model that combines the explainability of decision trees with the high accuracy of traditional ML techniques such as neural networks.

Unlike traditional decision trees that are limited to numeric or Boolean branches, embodiments of the present disclosure incorporate natural-language processing, vision and voice understanding, and advanced mathematical interpretation through code generation in branches. This makes embodiments of the present disclosure not only more precise but also makes the reasons for the results more understandable to humans.

Embodiments of the present disclosure address significant challenges in handling high-dimensional datasets. Traditional decision trees fail due to their inability to effectively separate data along non-linear lines, which is a strength of neural networks. By leveraging LLMs to categorize input fields through a question and answer (Q&A) format on input that may include unstructured text, vision and voice datasets and through mathematical calculations performed through code generation, trained machine learning models according to embodiments of the present disclosure dramatically reduce data sparsity. This is achieved without the costly, and often inaccurate, manual labeling and/or manual feature engineering.

Instead, aspects of embodiments of the present disclosure relate to applying LLM-based reasoning on multi-modal datasets and LLM-based code generation categorizes each branch node of the decision tree dynamically within each branch, guiding decision paths efficiently and accurately, thus offering a breakthrough in reducing sparsity.

Aspects of embodiments of the present disclosure also relate to a machine learning-driven, dynamic, and reliable approach to generating a model, compared to manual

LLM chaining, which relies on human intuition to construct LLM-based decision processes.

As will be described in more detail below, some aspects of the present disclosure relate to replacing one or more Boolean and/or numeric-based branches of a decision tree with natural-language processing and code generation operating on unstructured and/or structured datasets, which may be multi-modal datasets.

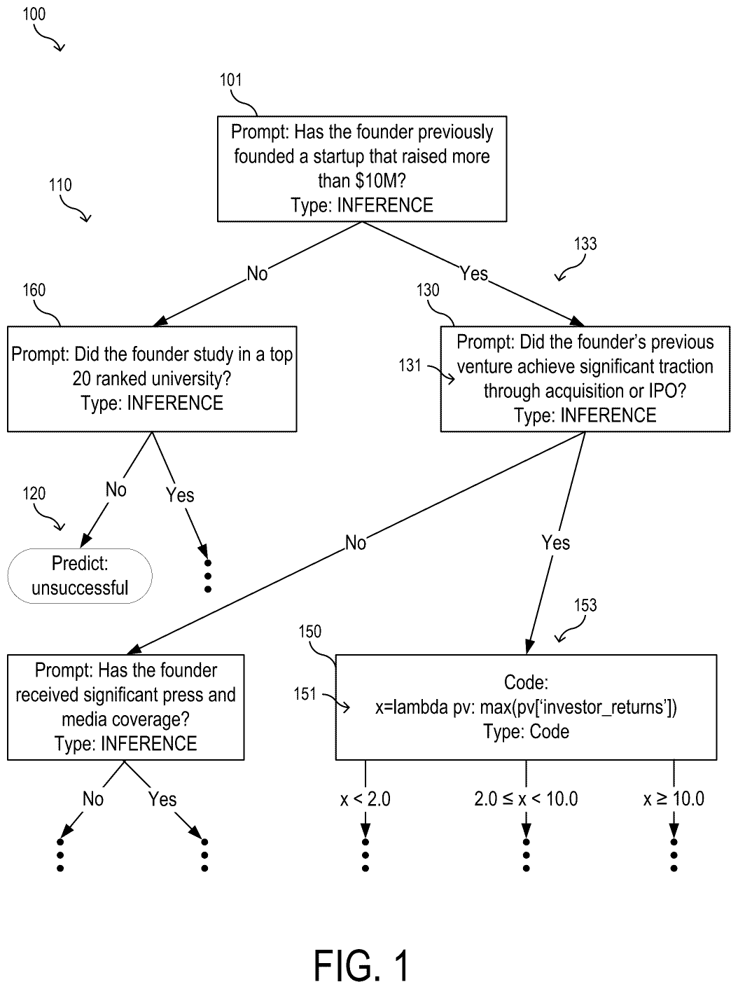

FIG. 1 is an example of a portion of a large language model (LLM) powered decision tree, according to one embodiment of the present disclosure. As shown in FIG. 1, an LLM-powered decision tree 100 according to embodiments of the present disclosure includes a plurality of nodes, including a root node 101, branch nodes 110, and leaf nodes 120. One or more of the root node 101 and the branch nodes 110 maybe inference nodes, where an inference node, such as inference node 130, is associated with a prompt 131 for prompting an LLM along with an input 133 to the inference node 130. The root node 101 and branch nodes 110 may also include code nodes, such as code node 150, which are associated with computer code 151 (e.g., a computer program or function) that is evaluated or executed based on the input 153 to the code node. The root node 101 and the branch nodes 110 represent decisions to be made within the decision tree 100 in the course of making a prediction, and the leaf nodes 120 represent the resulting predictions or include instructions (a prompt or computer code) for computing the prediction of the decision tree 100.

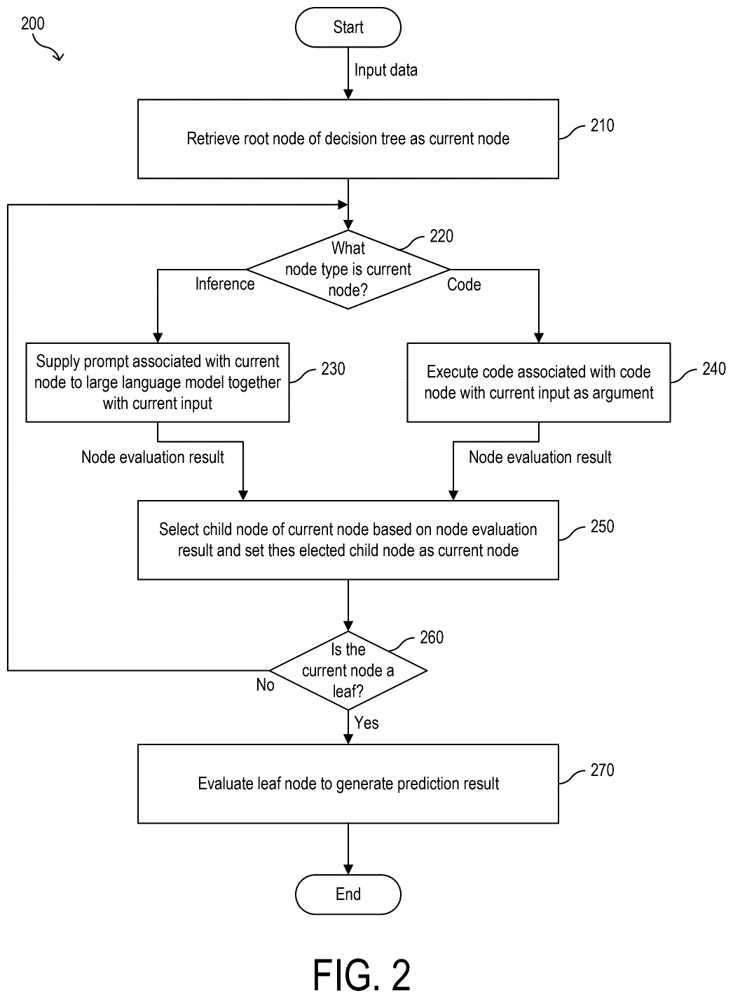

While FIG. 1 shows an LLM-powered decision tree that is trained and/or configured to predict the likelihood of success of a startup company based on aspects of its founder, embodiments of the present disclosure are not limited thereto and are applicable to other prediction problems, such as computing a likelihood that a transaction is fraudulent, predicting the most likely subject of a photographic composition (e.g., to control a camera to automatically focus on the subject), predicting a time of completion of a computational task (e.g., for task scheduling and computational resource allocation), and the like through the use of a computer system (including one or more processors or processing circuits) to automatically evaluate the LLM-powered decision tree in response to a given input, as will be described in more detail below with respect to FIG. 2.

In addition, while FIG. 1 shows an example where each inference node performs a binary split (e.g., each inference node has two child nodes), embodiments of the present disclosure are not limited thereto. For example, an inference node may be prompted to decide between three or more possible results and select between three or more corresponding child nodes and/or leaves. Furthermore, in some embodiments, one or more code nodes perform binary splits (e.g., have two child nodes).

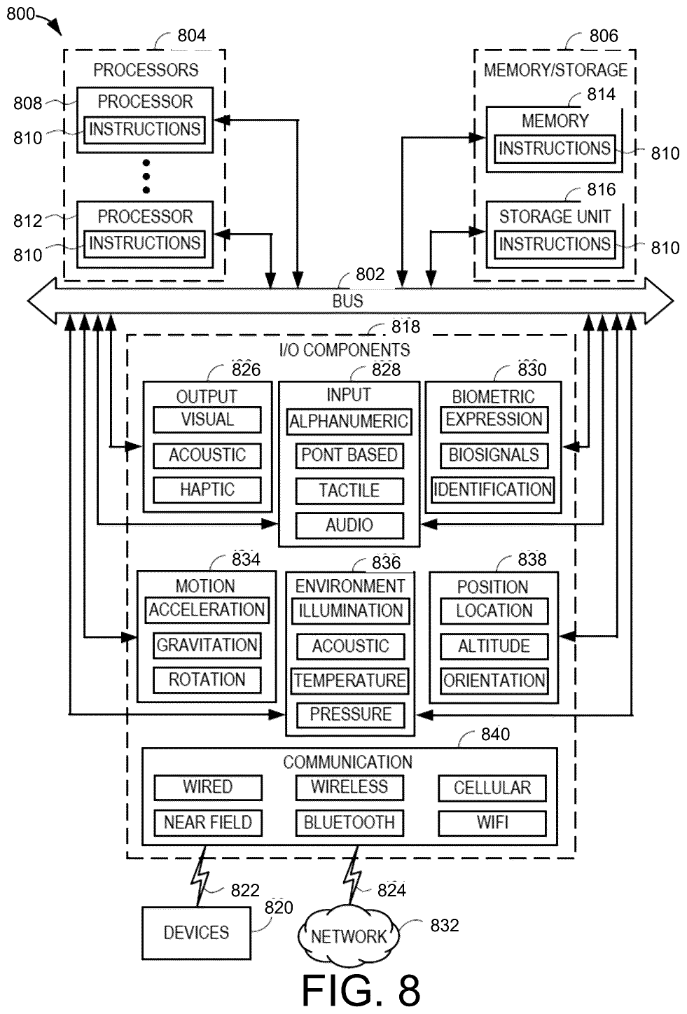

In various embodiments of the present disclosure, an LLM-powered decision tree such as that the LLM-powered decision tree 100 is evaluated using a computer system that includes on or more machines including one or more processors (see, e.g., machine 800 described in more detail below with respect to FIG. 8). In more detail, the LLM-powered decision tree may be represented as a data structure in a computer memory.

As noted above, an LLM-powered decision tree model that includes provides greater explainability than neural networks, enhances accuracy compared to traditional decision trees, and exceeds the reliability and efficiency of manually formed LLM chains. The invention surpasses our prior ML-based models in terms of precision and recall while bringing further explainability as shown in the attached Appendix: “GPTree: Towards Explainable Decision-Making via LLM-powered Decision Trees,” which is also incorporated by reference herein. As such, embodiments of the present disclosure provide a balanced solution that harnesses the strengths of both decision trees and advanced capabilities of LLMs.

FIG. 2 is a flowchart of a method 200 for traversing an LLM-powered decision tree to evaluate the decision tree and to produce a prediction in accordance with input data, according to one embodiment of the present disclosure. The method will be described herein with reference to the example decision tree 100 shown in FIG. 1. In some embodiments of the present disclosure, the operations of method 200 are performed by a computer system including one or more processing circuits and having instructions stored in one or more memories that, when executed by the one or more processing circuits, configure the computer system to implement the evaluation of an LLM-powered decision tree. For example, code nodes in the LLM-powered decision tree 100 include computer code that is executed (e.g., interpreted and/or compiled into machine instructions of an instruction set architecture of a processor), where the evaluation of a code node includes executing the computer code, with input derived from the input to the code node, to compute a decision associated with the node, such as choosing between direct child nodes of the code node. As another example, inference nodes in the LLM-powered decision tree are evaluated by supplying the prompt associated with the inference node, with input derived from the input to the inference node, to a computer system implementing the LLM. The computer system implementing the LLM may be the same machine that is evaluating the LLM-powered decision tree (e.g., in the case of a local LLM) or may be one or more other machines (e.g., a computer system including one or more processors and memories) accessed through an application programming interface (API) over a computer network (e.g., the internet).

The method 200 receives input data on which to perform a prediction using an LLM-powered decision tree. Continuing the example of FIG. 1, the input data may include information about a founder of a startup company, including biographical information, resume, social network profile, news articles regarding the founder, and the like, and the prediction to be computed is whether the current startup company will be successful. As another example, in a customer support scenario, an LLM-powered decision tree may be trained to handle customer queries, including receiving chat interaction data from a customer (e.g., to determine current customer sentiment and content to determine priority) and further receive prior transaction data between the customer and a company. As a third example, in the case where the LLM-powered decision tree is trained to diagnose medical conditions may receive input including photographs of a patient and lab results.

At 210, the computer system (e.g., the processor or processing circuit) retrieves a root node of an LLM-powered decision tree as a current node. For example, the LLM-powered decision tree may be stored in a computer memory such as a non-transitory computer-readable storage medium (e.g., a solid-state drive, a hard disk drive, an optical medium, or the like) and/or dynamic random-access memory (DRAM). At 220, the computer system determines what type of node the current node is, e.g., whether the current node is an inference node (e.g., in which a LLM is invoked to evaluate the node) or a code node (e.g., where computer code associated with the node is invoked or executed to evaluate the node).

In the case that the current node is an inference node, then at 230 the computer system invokes an LLM by supplying a prompt associated with the inference node along with a current input to the inference node to a large language model (LLM). As noted above, the LLM may be hosted locally on the same machine (or computer system) executing method 200 to evaluate the decision tree or may be hosted remotely (e.g., as an external service). In either circumstance, the LLM provides an interface (e.g., an application programming interface) for transmitting inputs to the LLM (e.g., text, images, audio, video, and the like) and receiving responses from the LLM (e.g., text, images, audio, video, and the like). An instruction-tuned language model is trained or fine-tuned such that it generates responses to inputs in a manner that mimics a conversation (e.g., implements a chatbot). Accordingly, an input to an instruction-tuned LLM that includes written instructions (e.g., a question) will generally result in generating a response that follows from that input (e.g., an answer to the question). Examples of such LLMs include, but are not limited to, the GPT® family of models from OpenAIR, Inc., the Claude® family of models from Anthropic®, PBC, the Llama® family of models from Meta® Platforms Inc., and the like. In some embodiments, calls (accesses) to the LLMs are batched (e.g., grouped together), cached (e.g., results of prior calls are saved and reused when inputs are identical), or parallelized (e.g., multiple calls to the LLM are sent at the same time with different data).

In the example shown in FIG. 1, the root node 101 includes the prompt text: “Has the founder previously founded a startup that raised more than $10M?” As noted above, in this example of a decision tree configured to predict the likelihood of success of a startup company based on aspects of its founder, the input to the decision tree 100 may include information about a founder of a startup company, including biographical information, resume, social network profile, news articles regarding the founder, and the like. In some embodiments, the LLM may be further configured to automatically perform internet searching to retrieve relevant documents. The received input and any relevant documents may be included as part of the context for the LLM to generate its response. Accordingly, assuming that the context includes information about the founder's prior history, then the LLM would be able to answer whether the founder previously founded a startup that raised more than ten million dollars.

The evaluation of the inference node at 230 produces a node evaluation result. This may include additional text generated by the LLM in response to the input, which includes information on which child node to select (e.g., the child node corresponding to an affirmative answer or the child node corresponding to a negative answer to the question). The additional text may also include additional context that is provided to child (or downstream) nodes of the decision tree (e.g., documents retrieved through the internet searches, which may be summarized or otherwise compressed by the LLM, structured data generated by the LLM suitable for consumption by code nodes such as using JavaScript Object Notation (JSON), and the like).

Similarly, in the case where the current node is a code node, then at 240 the computer system executes the code associated with the code node, providing the current input (or a portion thereof) as an argument. (For example, the input may include structured data that is appropriate to be provided as input to the code in the code node, such as data in JSON format.) In the example of FIG. 1, the code node 150 includes a line of code 151: “x=lambda pv: max (pv [′investor_returns′])”, which assumes that structured data was available regarding a prior venture (stored in variable prior_venture and passed as input argument pv to the lambda function), and that the this structured data includes a field called ‘investor_returns’ that stores the investment return multiples for all investors, and that a “max” function would return the highest value in a list. As such, the computer code 151 in the example code node 150 would store the value of the highest investor return multiple in the list and produce this value as a node evaluation result. In some embodiments, the computer code is expressed in an interpreted (or just-in-time compiled) computer language such as JavaScript or Python and therefore, when executed, is interpreted or just-in-time compiled by appropriate software (e.g., an interpreter) at the time of execution. In some embodiments, the computer code is stored as a compiled binary including machine instructions or bytecode (e.g., compiled in a library or stand-alone executable) and is executed by executing code of the compiled binary (e.g., executing the machine instructions on the processor or executing the bytecode using an interpreter or compiling the bytecode to machine instructions). In some embodiments, the computer code is a stateless (or pure) function or a lambda function that can partition structured features.

At 250, the computer system selects a child node from among the child nodes of the current node based on the node evaluation result and sets the selected child node to be the current node. For example, if the LLM answered the question in the prompt of the root node 101 in the affirmative, then the inference node 130 would be selected as the new current node, and if the LLM answered the question in the negative, then inference node 160 would be selected as the new current node instead.

At 260, the computer system determines if the current node is a leaf node. For example, if evaluating the inference node 160 resulted in a negative (or answer of “No”), then the selected child node would be leaf node 120.

If the current node is not a leaf, then the computer system proceeds with evaluating the current node at 220, selecting between different evaluation methods based on the type of node (e.g., inference node versus code node).

If the current node is a leaf, then at 270 the leaf node is evaluated to generate the prediction result. In the example of FIG. 1, the leaf node 120 merely contains the prediction that the startup will be unsuccessful. However, some leaf nodes may include further inferences or code to be evaluated—for example, the leaf node may include a prompt (a leaf prompt or a result prompt) for an LLM to generate a human-readable answer and explanation of the decisions that were made while evaluating each node that was traversed during the evaluation of the decision tree and provide context for the prediction. As another example, a leaf node may compute a result prediction (e.g., a numerical prediction) based on computer code (e.g., a regression function) specified in the leaf node based on values of input data provided to the leaf node as an argument (e.g., input data from the original input to the LLM-powered decision tree and/or data computed during evaluation of parent nodes along the path from the root node to the leaf node).

As such, an LLM-powered decision tree according to embodiments of the present disclosure further includes one or more nodes that invoke a large language model (e.g., an instruction-tuned large language model) to perform a split (e.g., categorize the input data into one of a plurality of categories) that controls what further decisions and computational steps are performed on the input data in computing a prediction.

Aspects of embodiments of the present disclosure relate to automatically constructing an LLM-powered decision tree. In more detail, embodiments of the present disclosure adapt to any number of input fields and types including unstructured text, making it suitable for a vast range of applications. It is not purpose-built for specific types of data, allowing for broad usability across various industries. The reasoning capabilities of LLMs enables embodiments of the present disclosure to perform effectively, even with smaller datasets, by utilizing its extensive knowledge base, thus facilitating learning and adaptation in data-sparse scenarios.

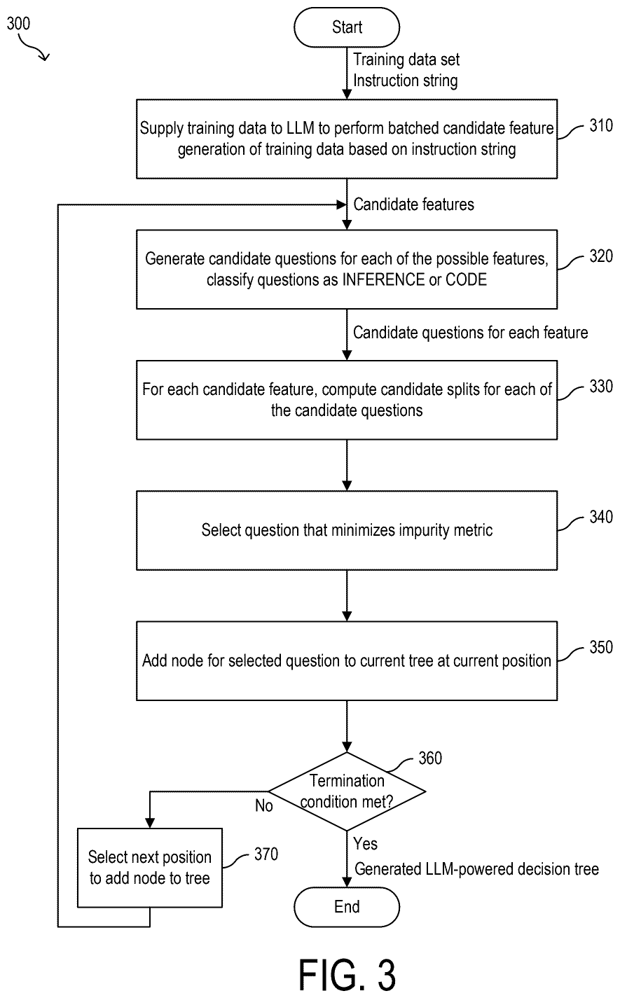

FIG. 3 is a flowchart of a method 300 for training an LLM-powered decision tree, according to one embodiment of the present disclosure. In some embodiments of the present disclosure, the operations of method 300 are performed by a computer system including one or more processing circuits and having instructions stored in one or more memories that, when executed by the one or more processing circuits, configure the computer system to implement the training of an LLM-powered decision tree. As noted above, an LLM-powered decision tree according to some embodiment of the present disclosure is a hybrid decision tree that includes at least some LLM-based nodes (“inference nodes”) and which may also include code-based nodes.

The input to the method 300 includes an input training data set, including input fields and output fields (or labels), and a domain-specific instruction string that describes the intended decision-making context. Referring to the example of FIG. 1, the domain-specific instruction string may be “a venture capitalist evaluating founders” and the training data set may include profiles of founders of a collection of startups and output fields (or labels) in the form of whether those startups were successful or unsuccessful.

At 310, the training data is provided to an LLM that is prompted to perform batched candidate feature generation of the training data. In some embodiments, the prompt includes instructions to summarize the classified samples (e.g. positive vs negative examples) from the training data set in manageable groups (˜250) in a ratio of preference (e.g. 50% positive, 50% negative examples) and to synthesize recurring patterns in the training data into a concise list of candidate features that guide downstream splits. For example, in the case of an LLM-powered decision tree to predict whether a startup will be successful based on characteristics of a founder, the LLM may be prompted at 310 with the following instruction: “Imagine you are a VC analyst. Analyze the given data of successful founders and identify features or success patterns. Provide a concise summary of these common characteristics/traits.”

At 320, for each candidate feature, the computer system performs generates a plurality of candidate questions by producing a few (e.g., up to three, or more) possible split conditions conditioned on the task context (specified by the instruction string) and the candidate features computed at 310. For example, in the case of an LLM-powered decision tree to predict whether a startup will be successful based on characteristics of a founder, the LLM may be prompted at 320 with the following instruction: “Your task is to distinguish successful from unsuccessful ones by generating precise questions based on a given Dataframe containing various founder features. You are to act as a decision node in a decision tree, formulating questions that can help distinguish successful founders.”

Each question is also classified as an INFERENCE question to be implemented by an INFERENCE node (e.g., having an associated prompt that configures an LLM to evaluate unstructured or multi-modal text/image/audio) or a CODE question to be implemented by a CODE node (e.g., having associated LLM-generated code that is deterministic, which splits structured data when executed by a processor). In some embodiments, the LLM-generated code is expressed in an interpreted computer programming language such as JavaScript or Python. In some embodiments, the LLM-generated source code is expressed in a compiled computer programming language such as C, and the generated code may be compiled such that evaluating the code node executes the binary file compiled from the generated source code. The computer system then generates a collection of candidate questions (which may be inference nodes and/or code nodes) corresponding to the candidate features.

At 330, for each feature, the computer system computes the samples for the candidate splits for each question, after checking that they meet the minimum number of required samples (e.g., that the question meaningfully splits the current data samples into two or more sub-groups), at 340 selects the question that minimizes an impurity metric (e.g., weighted Gini, entropy, and the like) at a current node of the decision tree being constructed. In some embodiments, the weighted Gini impurity formula is expressed as:

$${G}_{weighted} = {\sum }_{i = 1}^{k} \frac{{n}_{i}}{N} {G}_{i} \qquad ( 1 )$$

where k is the number of child nodes after the split (e.g., 2), nᵢ is the number of samples in the i-th child node, N is the total number of samples across all child nodes

$$( i . e . , N = {Σ}_{i = 1}^{k} {n}_{i} ) ,$$

Gᵢ is the Gini impurity of the i-th child node:

$${G}_{i} = 1 - {\sum }_{j = 1}^{c} {p}_{i j}^{2} \qquad ( 2 )$$

where C is the number of classes, pᵢⱼ is the proportion of samples in the i-th child node that belongs to class j.

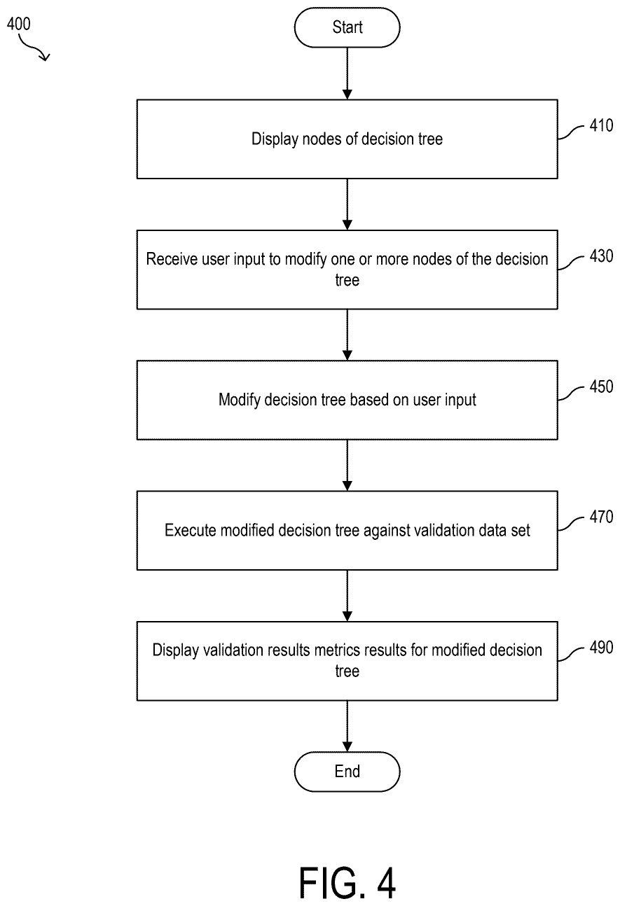

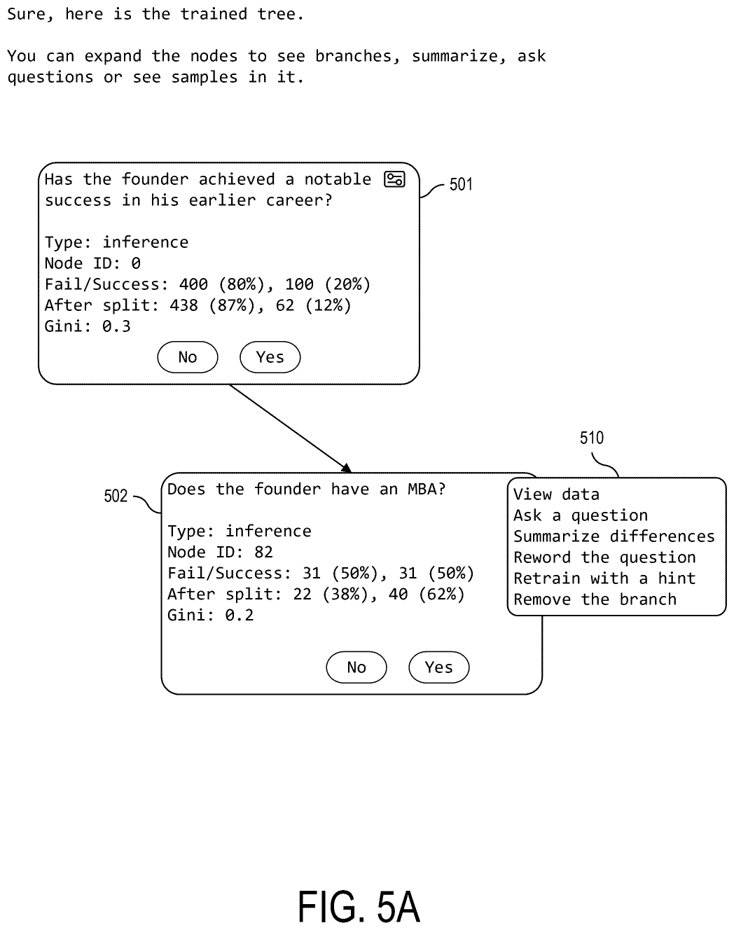

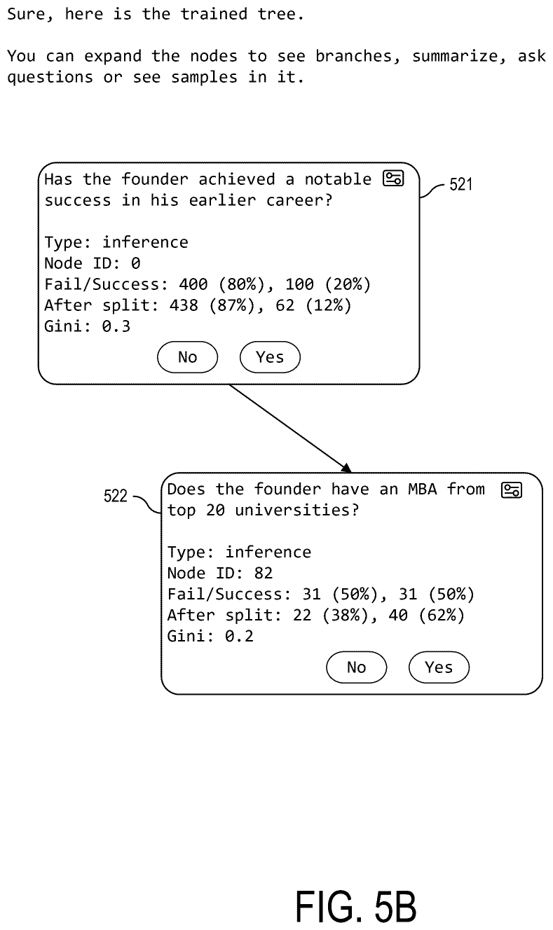

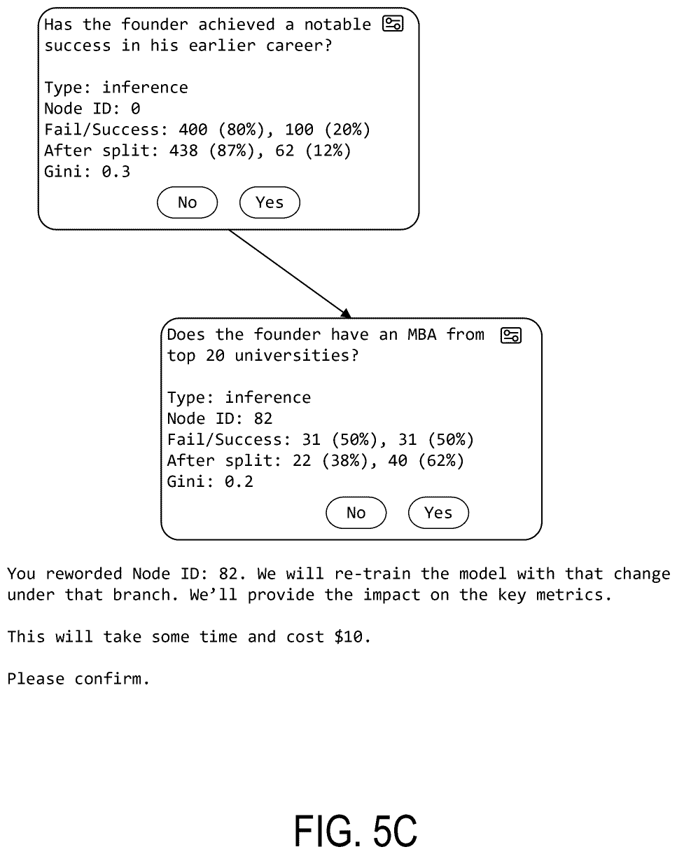

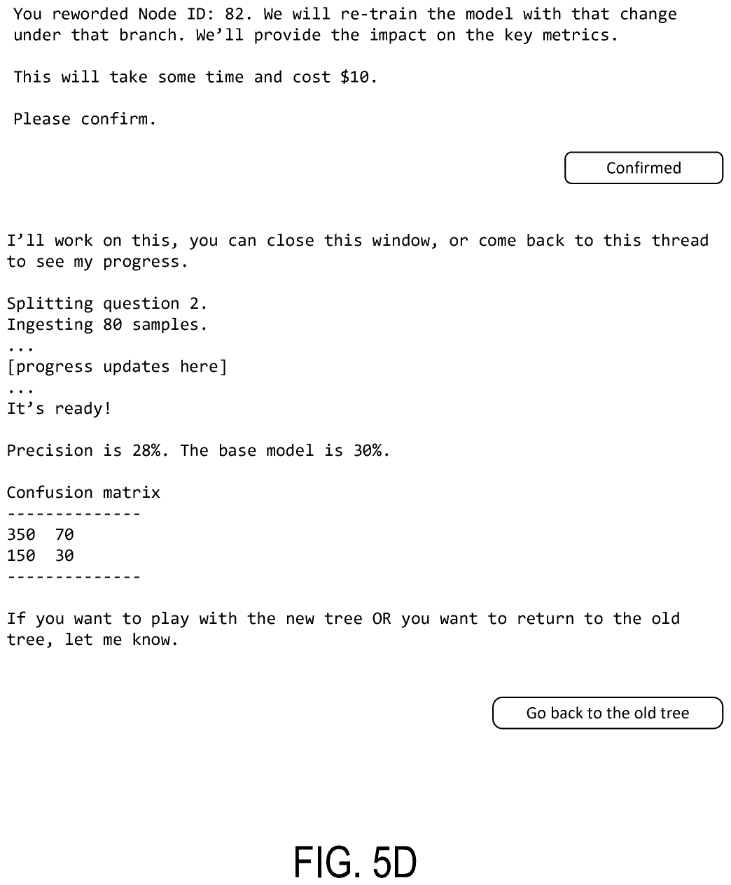

In some embodiments, the candidate splits and impurity metrics computed for each of the questions is displayed to a user (e.g., a subject matter expert) to review the choice and who can edit to the candidate questions and re-run the calculations, as will be discussed in more detail below with respect to FIGS. 4, 5A, 5B, 5C, and 5D.

After a split is chosen at 340, the computer system updates a cumulative memory that adds the selected question as a node to the tree and summarizes the path so far (e.g., selected features, prompt questions or computer code for each node, node class statistics, and any expert advice collected from human users).

In some embodiments, when the training is conducted with expert involvement during training (e.g., expert-during-training=True), the process is paused after each node is added to the tree. This pause allows for further expert contributions, such as domain insights, contextual details, or specific regulations, thereby influencing subsequent node generations. If the Expert-during-training flag is set to False, this step is omitted. User involvement will be described in more detail below with respect to FIGS. 4, 5A, 5B, 5C, and 5D.

At 360, the computer system determines if termination conditions have been met, such as whether a minimum number of samples per node is met for every node and/or a maximum depth is reached for a given branch of the tree or if a particular node becomes “pure” (e.g., no further splits are possible).

Based on whether a termination condition has been met for a current branch, the computer system selects a next position to add a node to the tree (e.g., proceeding depth-first until one of the termination conditions is met, then backtracking and proceeding to generate other branches of the tree). As such, at 370, the computer system selects a next position to add a node to the tree (e.g., as a child node of the current node, or as a sibling node to another node closer to the root node of the decision tree) and proceeds with generating subsequent candidate questions for the new node at 320.

When generating each subsequent child node, some embodiments of the present disclosure provide the cumulative memory as non-restrictive advice for candidate generation (it can bias or de-duplicate proposals without imposing hard constraints). The tree is then built greedily by the impurity objective and recursion continues until stopping criteria (or termination condition) are met.

When the termination condition has been met for all branches of the decision tree, then the method 300 is complete and the computer system returns a constructed LLM-powered decision tree.

As such, the method 300 automates the generation of an LLM-powered decision tree, thereby avoiding the need for humans to perform manual feature engineering or prompt chaining (e.g., chaining of calls to LLMs).

Given that nodes are described in natural language, some aspects of embodiments of the present disclosure relate to providing user interfaces for users (e.g., domain experts) to be active participants during training and performing system-provided operations to collapse nodes, rebuild subtrees, reword questions, and interrogate samples post-training. In more detail, some aspects of embodiments of the present disclosure relate to automatically executing these edits and regenerating the LLM-powered decision tree without involving an engineer (e.g., technical expert on decision trees).

FIG. 4 is a flowchart of a method 400 for modifying an LLM-powered decision tree, according to one embodiment of the present disclosure. In some embodiments of the present disclosure, the operations of method 400 are performed by a computer system including one or more processing circuits and having instructions stored in one or more memories that, when executed by the one or more processing circuits, configure the computer system to implement a method for modifying an LLM-powered decision tree.

At 410, the computer system displays nodes of a decision tree. The displayed nodes may represent a portion of the tree if performed during training or generation of the tree as shown in FIG. 3, or may represent the completed tree, if performed after generating the tree. FIG. 5A is a screenshot of a portion of a user interface for modifying a node of an LLM-powered decision tree, according to one embodiment of the present disclosure. As shown in FIG. 5A, the user interface shows a first node 501 and a second node 502 of a decision tree, where a user has selected the second node 502 for modification. A pop-up menu 510 shows various options, including: View data (to show training data that would be split by the question), Ask a question (to interact with a chatbot to request more information about the node); and Summarize differences (to interact with a chatbot to summarize differences between the splits), as well as commands to modify the node, including “Reword the question”, “Retrain with a hint” (e.g., rebuild the subtree with additional advice), and “Remove the branch” (e.g., to remove trivial nodes that, for example, do not meaningfully split the data, from the decision tree). Continuing the example from FIG. 1, an example of a hint for regenerating the tree could be: “Consider if the founder worked at big tech companies such as Google, Microsoft, Apple and Facebook/Meta. Consider if the founder worked at a public tech company (NASDAQ). Consider if the founder has studied at a top 20 ranked university based on QS World University Ranking 2023.”

FIG. 5B is a screenshot of a portion of a user interface for editing a question or prompt of an inference node of an LLM-powered decision tree, according to one embodiment of the present disclosure, such as where the user selected the “Reword the question” option from the pop-up menu 510. As shown in FIG. 5B, the first node 521 is unmodified compared to original first node 501, but the prompt question in the second node 502 originally read “Does the founder has an MBA?” has been changed by the user to “Does the founder have an MBA from top 20 universities?”

As such, at 430, the computer system receives user input to modify one or more of the nodes of the decision tree, such as to edit a prompt or code associated with a node as shown in FIG. 5B, to delete a node, or to provide a text hint to be included in the prompt or context for re-generating the decision tree or a branch of the decision tree.

At 450, the computer system modifies the decision tree based on the user input. In some embodiments, the computer system requests that a user confirm the edits, providing a cost estimate for computing the edits (e.g., based on number of tokens expected to be consumed by an LLM to execute the changes). FIG. 5C is a screenshot of a portion of a user interface requesting that a user confirm the edits to the inference node, according to one embodiment of the present disclosure.

At 470, the computer system runs the modified model on a validation data set to measure the performance of the modifications. FIG. 5D is a screenshot of a portion of a user interface showing test results of the LLM-powered decision tree after applying the user's edits to the inference node (e.g., accuracy, precision, and recall), and offering options to revert the change, according to one embodiment of the present disclosure. In the example of FIG. 5D, the resulting precision after the change was 28% whereas the precision in the base model was 39%. The user interface further displays a confusion matrix computed based on the modified decision tree. In some embodiments, the validation data set is used to perform pruning of the decision tree (removal of nodes)

In some embodiments, the computer system guides a user in performing sensitivity selection, such as choosing a cutoff threshold that maximizes an F score (e.g. F_{0.5}/F₁/F₂) based on the objective to balance precision/recall (e.g., decision trees for investing versus medical diagnosis have different appropriate F scores). In some embodiments, the model is further evaluating using stratified k-fold cross validation.

After computing the updated decision tree the decision tree may be deployed for use, where evaluation proceeds, for example, based on the method 200 described above with respect to FIG. 2—inference or LLM nodes answer contextual questions on unstructured or multi-modal data input, and code nodes execute functions on structured fields, and the path to the leaf produces both classification and explainable rationale.

As noted above, the LLM or different LLMs that are invoked at inference nodes are, in some embodiments, multi-modal LLMs and therefore the inputs may include permutations of the available modalities, such as text; text+structured tables; text+images; full multi-modal data (speech, images, video).

In some embodiments, the nodes may also vary based on node input styles, such as: static features with no memory; augmented with outputs of prior nodes; per-node memory to retain information from prior inputs.

While aspects of embodiments of the present disclosure are presented above with two types of nodes (inference nodes and code nodes), embodiments of the present disclosure are not limited to these two types of nodes and an LLM-powered decision tree according to any of the embodiments of the present disclosure may further include one or more additional types of nodes. One example of an additional type of node is a clustering node for categorical features: when a categorical feature has more than a branching cap (B) categories then, in some embodiments an LLM is used to propose semantic groupings so the effective branching is less than or equal to the branching cap, such as by evaluating each grouping with the same weighted-impurity objective. Additionally, in some embodiments, code nodes may further include regex-based nodes, and statistical and machine learning-based nodes.

Embodiments of the present disclosure may be most useful to verticals where quantitative data is limited and decisions rely on qualitative judgment, including venture capital investment, judicial decision-making, litigation strategy (e.g., judge selection), and research-grant allocation by universities or funding bodies.

According to one embodiment of the present disclosure, a system includes: a processor; and a memory storing instructions that, when executed by the processor, cause the processor to evaluate a decision tree including a plurality of nodes including: providing a first input data to an inference node of the decision tree, the inference node being associated with a prompt for instructing a large language model and a plurality of child nodes; supplying the prompt of the inference node and the first input data to a large language model to computing a node evaluation result of the inference node; selecting a child node from among the plurality of child nodes of the inference node based on the node evaluation result computed by the large language model; and generating a prediction of the decision tree in accordance with a leaf node selected from a plurality of leaf nodes of the decision tree.

The prompt of the inference node may be generated by a large language model to generate a split between data samples of a training data set.

The plurality of nodes may further include a code node having associated computer code and a second plurality of child nodes, and the memory may further store instructions that, when executed by the processor, cause the processor to evaluate the code node by providing a second input data to the code node, executing the associated computer code of the code node with the second input data as an argument to compute a second node evaluation result; and selecting a second child node from among the second plurality of child nodes.

The associated computer code of the code node may be generated by a large language model to generate a split between data samples of a training data set.

The second input data to the code node may include data generated by the large language model in the node evaluation result.

According to one embodiment of the present disclosure, a method for training a large language model (LLM) powered decision tree, includes adding a node to the LLM-powered decision tree by: receiving training data including a plurality of data samples having input fields and output fields; receiving a domain-specific instruction string describing a decision-making context for the LLM-powered decision tree; generating, by a processor, a plurality of candidate features by supplying the domain-specific instruction string and the training data to a large language model (LLM); generating, by the processor, a plurality of candidate questions for each of the plurality of candidate features by supplying the plurality of features and the training data to the LLM, the candidate questions including inference questions and code questions; computing candidate splits of the training data for each of the candidate questions; selecting, by the processor, a question of the candidate questions based on minimizing an impurity metric; and generating the node to be added to the LLM-powered decision tree based on the selected question.

The method may further include iteratively adding a plurality of nodes to the LLM-powered decision tree until a plurality of stopping criteria are met for a plurality of branches of the LLM-powered decision tree.

The method may further include: displaying the node in a user interface; receiving a modification to the node via the user interface; and modifying the LLM-powered decision tree based on the modification to the node.

The method may further include: executing the modified LLM-powered decision tree against a validation data set; and displaying validation results metrics for the modified LLM-powered decision tree in the user interface.

The method may further include: receiving a user confirmation of the node before adding a next node to the LLM-powered decision tree.

The next node may be configured to receive an input generated by the node.

The modification may include a rewording of the selected question associated with the node.

The modification may include supplying a text hint that is included in a context supplied to the LLM to generate the plurality of candidate questions.

The modification may include a deletion of the node.

According to one embodiment of the present disclosure, a non-transitory computer-readable medium stores a data structure that represents a decision tree, the data structure including: a root node; a plurality of leaf nodes representing outputs of the decision tree selected based on traversing the decision tree by a processor of a computer system; and a plurality of branch nodes connected between the root node and the plurality of leaf nodes, the branch nodes including an inference node having a prompt, wherein evaluating the inference node during traversal of the decision tree includes: supplying the prompt and a first input data of the inference node to a large language model (LLM) to compute a first node evaluation result; and selecting a first child node of a plurality of child nodes of the inference node based on the first node evaluation result and evaluating the first child node to continue the traversal of the decision tree.

The prompt of the inference node may be generated automatically by a LLM prompted to generate prompts to split a training data set.

The plurality of branch nodes may further include a code node including computer code, and evaluating the code node during traversal of the decision tree may include:

executing the computer code of the code node with a second input data of the code node as an argument to compute a second node evaluation result; and selecting a second child node of a plurality of second child nodes of the code node based on the second node evaluation result and evaluating the second child node to continue the traversal of the decision tree.

The prompt of the code node may be generated automatically by a LLM prompted to generate computer code to split a training data set.

A leaf node of the plurality of leaf nodes may include a leaf prompt that, when supplied to a LLM together with an input to the leaf node, causes the LLM to generate a human-readable output of the decision tree.

A leaf node of the plurality of leaf nodes may include computer code that, when executed by a processor with an input to the leaf node as an argument, causes the processor to compute an output of the decision tree.

An LLM-powered decision tree may be deployed locally to run directly on a user's computer system or may be deployed in a cloud-based service and accessed by users over a computer network (such as the internet) as software as a service (Saas).

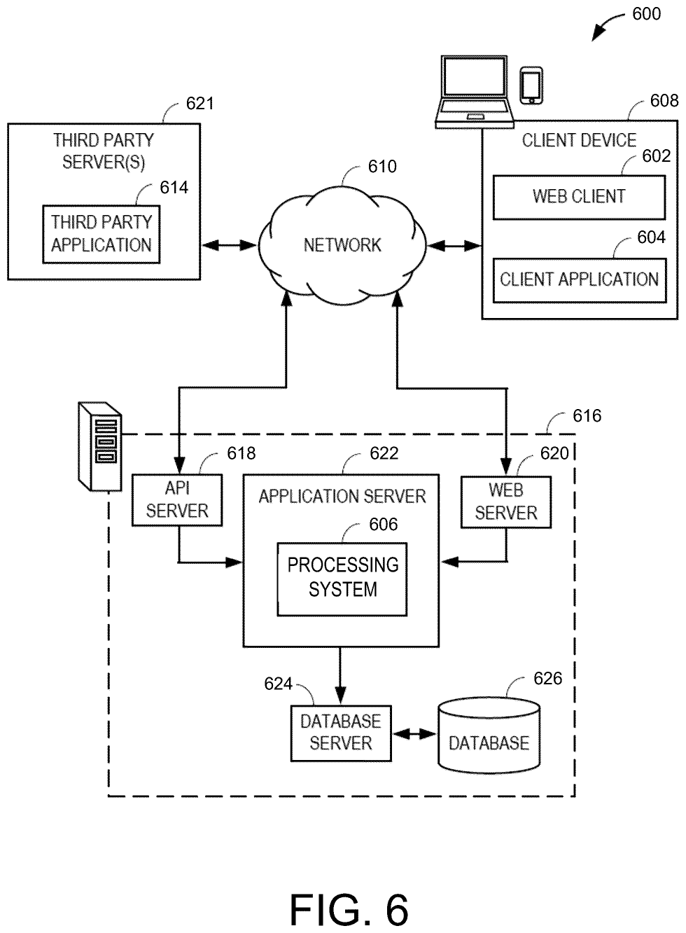

With reference to FIG. 6, an example embodiment of a high-level SaaS network architecture 600 is shown. A networked system 616 provides server-side functionality via a network 610 (e.g., the Internet or a WAN) to a client device 608. A web client 602 and a programmatic client, in the example form of a client application 604 (e.g., client software for accessing or training an LLM-powered decision tree), are hosted and execute on the client device 608. The networked system 616 includes one or more servers 622 (e.g., servers hosting services exposing remote procedure call APIs), which hosts a processing system 606 (such as the processing system described above according to various embodiments of the present disclosure supporting a service for training and deploying LLM-powered decision trees) that provides a number of functions and services via a service oriented architecture (SOA) and that exposes services to the client application 604 that accesses the networked system 616 where the services may correspond to particular workflows. The client application 604 also provides a number of interfaces described herein, which can present an output in accordance with the methods described herein to a user of the client device 608.

The client device 608 enables a user to access and interact with the networked system 616 and, ultimately, the processing system 606. For instance, the user provides input (e.g., touch screen input or alphanumeric input) to the client device 608, and the input is communicated to the networked system 616 via the network 610. In this instance, the networked system 616, in response to receiving the input from the user, communicates information back to the client device 608 via the network 610 to be presented to the user.

An API server 618 and a web server 620 are coupled, and provide programmatic and web interfaces respectively, to the servers 622. For example, the API server 618 and the web server 620 may produce messages (e.g., RPC calls) in response to inputs received via the network, where the messages are supplied as input messages to workflows orchestrated by the processing system 606. The API server 618 and the web server 620 may also receive return values (return messages) from the processing system 606 and return results to calling parties (e.g., web clients 602 and client applications 604 running on client devices 608 and third-party applications 614) via the network 610. The servers 622 host the processing system 606, which includes components or applications in accordance with embodiments of the present disclosure as described above. The servers 622 are, in turn, shown to be coupled to one or more database servers 624 that facilitate access to information storage repositories (e.g., databases 626). In an example embodiment, the databases 626 includes storage devices that store information accessed and generated by the processing system 606 and the persistent store 680 of FIG. 6 and other databases such as databases storing documents that may be retrieved for supplementing the context provided to LLMs (e.g., based on retrieval augmented generation).

Additionally, a third-party application 614, executing on one or more third-party servers 621, is shown as having programmatic access to the networked system 616 via the programmatic interface provided by the API server 618. For example, the third-party application 614, using information retrieved from the networked system 616, may support one or more features or functions on a website hosted by a third-party. For example, the third-party application 614 may provide a cloud-based large language model (LLM). Turning now specifically to the applications hosted by the client device 608, the web client 602 may access the various systems (e.g., the processing system 606) via the web interface supported by the web server 620. Similarly, the client application 604 (e.g., an “app” such as an) may access the various services and functions provided by the processing system 606 via the programmatic interface provided by the API server 618. The client application 604 may be, for example, an “app” executing on the client device 608, such as an iOS or Android OS application to enable a user to access and input data on the networked system 616 in an offline manner and to perform batch-mode communications between the client application 604 and the networked system 616.

Further, while the network architecture 600 shown in FIG. 6 employs a client-server architecture, the present disclosure is not limited to such an architecture, and could equally well find application in a distributed, or peer-to-peer, architecture system, for example.

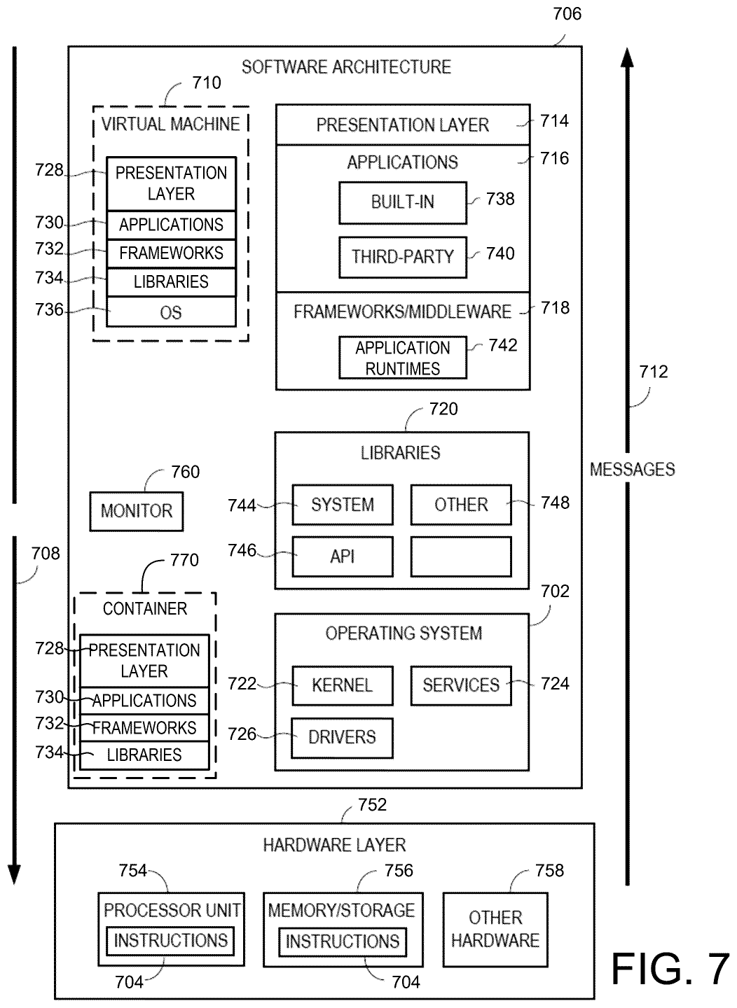

FIG. 7 is a block diagram illustrating an example software architecture 706, which may be used in conjunction with various hardware architectures herein described. FIG. 7 is a non-limiting example of a software architecture 706, and it will be appreciated that many other architectures may be implemented to facilitate the functionality described herein. The software architecture 706 may execute on hardware such as a machine 800 of FIG. 8 that includes, among other things, processors 804, memory/storage 806, and input/output (I/O) components 818. A representative hardware layer 752 is illustrated and can represent, for example, the machine 800 of FIG. 8. The representative hardware layer 752 includes a processor 754 having associated executable instructions 704. The executable instructions 704 represent the executable instructions of the software architecture 706, including implementation of the methods, components, and so forth described herein. The hardware layer 752 also includes non-transitory memory and/or storage modules as memory/storage 756, which also have the executable instructions 704. The hardware layer 752 may also include other hardware 758.

In the example architecture of FIG. 7, the software architecture 706 may be conceptualized as a stack of layers where each layer provides particular functionality. For example, the software architecture 706 may include layers such as an operating system 702, libraries 720, frameworks/middleware 718, applications 716 (such as the services of the processing system), and a presentation layer 714. Operationally, the applications 716 and/or other components within the layers may invoke API calls 708 through the software stack and receive a response as messages 712 in response to the API calls 708. The layers illustrated are representative in nature, and not all software architectures have all layers.

For example, some mobile or special-purpose operating systems may not provide a frameworks/middleware 718, while others may provide such a layer. Other software architectures may include additional or different layers.

The operating system 702 may manage hardware resources and provide common services. The operating system 702 may include, for example, a kernel 722, services 724, and drivers 726. The kernel 722 may act as an abstraction layer between the hardware and the other software layers. For example, the kernel 722 may be responsible for memory management, processor management (e.g., scheduling), component management, networking, security settings, and so on. The services 724 may provide other common services for the other software layers. The drivers 726 are responsible for controlling or interfacing with the underlying hardware. For instance, the drivers 726 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 720 provide a common infrastructure that is used by the applications 716 and/or other components and/or layers. The libraries 720 provide functionality that allows other software components to perform tasks in an easier fashion than by interfacing directly with the underlying operating system 702 functionality (e.g., kernel 722, services 724, and/or drivers 726). The libraries 720 may include system libraries 744 (e.g., C standard library) that may provide functions such as memory allocation functions, string manipulation functions, mathematical functions, and the like. In addition, the libraries 720 may include API libraries 746 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), and the like. The libraries 720 may also include a wide variety of other libraries 748 to provide many other APIs to the applications 716 and other software components/modules.

The frameworks/middleware 718 provide a higher-level common infrastructure that may be used by the applications 716 and/or other software components/modules. For example, the frameworks/middleware 718 may provide high-level resource management functions, web application frameworks, application runtimes 742 (e.g., a Java virtual machine or JVM), and so forth. The frameworks/middleware 718 may provide a broad spectrum of other APIs that may be utilized by the applications 716 and/or other software components/modules, some of which may be specific to a particular operating system or platform.

The applications 716 include built-in applications 738 and/or third-party applications 740. The applications 716 may use built-in operating system functions (e.g., kernel 722, services 724, and/or drivers 726), libraries 720, and frameworks/middleware 718 to create user interfaces to interact with users of the system. Alternatively, or additionally, in some systems, interactions with a user may occur through a presentation layer, such as the presentation layer 714. In these systems, the application/component “logic” can be separated from the aspects of the application/component that interact with a user.

Some software architectures use virtual machines. In the example of FIG. 7, this is illustrated by a virtual machine 710. The virtual machine 710 creates a software environment where applications/components can execute as if they were executing on a hardware machine (such as the machine 800 of FIG. 8, for example). The virtual machine 710 is hosted by a host operating system (e.g., the operating system 702 in FIG. 7) and typically, although not always, has a virtual machine monitor 760 (or hypervisor), which manages the operation of the virtual machine 710 as well as the interface with the host operating system (e.g., the operating system 702). A software architecture executes within the virtual machine 710 such as an operating system (OS) 736, libraries 734, frameworks 732, applications 730, and/or a presentation layer 728. These layers of software architecture executing within the virtual machine 710 can be the same as corresponding layers previously described or may be different.

Some software architectures use containers 770 or containerization to isolate applications. The phrase “container image” refers to a software package (e.g., a static image) that includes configuration information for deploying an application, along with dependencies such as software components, frameworks, or libraries that are required for deploying and executing the application. As discussed herein, the term “container” refers to an instance of a container image, and an application executes within an execution environment provided by the container. Further, multiple instances of an application can be deployed from the same container image (e.g., where each application instance executes within its own container). Additionally, as referred to herein, the term “pod” refers to a set of containers that accesses shared resources (e.g., network, storage), and one or more pods can be executed by a given computing node. A container 770 is similar to a virtual machine in that it includes a software architecture including libraries 734, frameworks 732, applications 730, and/or a presentation layer 728, but omits an operating system and, instead, communicates with the underlying host operating system 702.

FIG. 8 is a block diagram illustrating components of a machine 800, according to some example embodiments, able to read instructions from a non-transitory machine-readable medium (e.g., a computer-readable storage medium) and perform any one or more of the methodologies discussed herein. Specifically, FIG. 8 shows a diagrammatic representation of the machine 800 in the example form of a computer system, within which instructions 810 (e.g., software, a program, an application, an applet, an app, or other executable code) for causing the machine 800 to perform any one or more of the methodologies discussed herein may be executed. As such, the instructions 810 may be used to implement modules or components described herein. The instructions 810 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may include, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 810, sequentially or in parallel or concurrently, that specify actions to be taken by the machine 800. Further, while only a single machine 800 is illustrated, the term “machine” or “processing circuit” shall also be taken to include a collection of machines that individually or jointly execute the instructions 810 to perform any one or more of the methodologies discussed herein.

The machine 800 may include processors 804 (including processors 808 and 812), memory/storage 806, and I/O components 818, which may be configured to communicate with each other such as via a bus 802. The memory/storage 806 may include a memory 814, such as a main memory, or other memory storage, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814, within the storage unit 816, within at least one of the processors 804 (e.g., within the processor's cache memory), or any suitable combination thereof, during execution thereof by the machine 800. Accordingly, the memory 814, the storage unit 816, and the memory of the processors 804 are examples of machine-readable media.

The I/O components 818 may include a wide variety of components to receive input, provide output, produce output, transmit information, exchange information, capture measurements, and so on. The specific I/O components 818 that are included in a particular machine will depend on the type of machine. For example, portable machines such as mobile phones may include a touch input device or other such input mechanisms, while a headless server machine will likely not include such a touch input device. It will be appreciated that the I/O components 818 may include many other components that are not shown in FIG. 8. The I/O components 818 are grouped according to functionality merely for simplifying the following discussion, and the grouping is in no way limiting. In various example embodiments, the I/O components 818 may include output components 826 and input components 828. The output components 826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 818 may include biometric components 830, motion components 834, environment components 836, or position components 838, among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 834 may include acceleration sensor components (e.g., accelerometer), gravitation sensor components, rotation sensor components (e.g., gyroscope), and so forth. The environment components 836 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a network 832 or devices 820 via a coupling 824 and a coupling 822, respectively. For example, the communication components 840 may include a network interface component or other suitable device to interface with the network 832. In further examples, the communication components 840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a USB).

Moreover, the communication components 840 may detect identifiers or include components operable to detect identifiers. For example, the communication components 840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840, such as location via Internet Protocol (IP) geo-location, location via Wi-Fi® signal triangulation, location via detecting an NFC beacon signal that may indicate a particular location, and so forth.

The term non-transitory computer-readable medium is to be understood herein to refer to one or more non-transitory computer-readable media, such as a single solid-state drive, multiple solid-state drives connected in a redundant array of independent drives, one or more hard disk drives (e.g., magnetic data storage media), one or more optical (e.g., CD-ROM or DVD-ROM) media, one or more pools of data storage devices connected to one or more computer servers, and the like.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A system comprising:
a processor; and
a memory storing instructions that, when executed by the processor, cause the processor to evaluate a decision tree comprising a plurality of nodes comprising:
providing a first input data to an inference node of the decision tree, the inference node being associated with a prompt for instructing a large language model and a plurality of child nodes;
supplying the prompt of the inference node and the first input data to a large language model to computing a node evaluation result of the inference node;
selecting a child node from among the plurality of child nodes of the inference node based on the node evaluation result computed by the large language model; and
generating a prediction of the decision tree in accordance with a leaf node selected from a plurality of leaf nodes of the decision tree.

2. The system of claim 1, wherein the prompt of the inference node was generated by a large language model to generate a split between data samples of a training data set.

3. The system of claim 1, wherein the plurality of nodes further comprises a code node having associated computer code and a second plurality of child nodes, and
wherein the memory further stores instructions that, when executed by the processor, cause the processor to evaluate the code node by:
providing a second input data to the code node,
executing the associated computer code of the code node with the second input data as an argument to compute a second node evaluation result; and
selecting a second child node from among the second plurality of child nodes.

4. The system of claim 3, wherein the associated computer code of the code node was generated by a large language model to generate a split between data samples of a training data set.

5. The system of claim 3, wherein the second input data to the code node comprises data generated by the large language model in the node evaluation result.

6. A method for training a large language model (LLM) powered decision tree, comprising adding a node to the LLM-powered decision tree by:
receiving training data comprising a plurality of data samples having input fields and output fields;
receiving a domain-specific instruction string describing a decision-making context for the LLM-powered decision tree;
generating, by a processor, a plurality of candidate features by supplying the domain-specific instruction string and the training data to a large language model (LLM);
generating, by the processor, a plurality of candidate questions for each of the plurality of candidate features by supplying the plurality of features and the training data to the LLM, the candidate questions comprising inference questions and code questions;
computing candidate splits of the training data for each of the candidate questions;
selecting, by the processor, a question of the candidate questions based on minimizing an impurity metric; and
generating the node to be added to the LLM-powered decision tree based on the selected question.

7. The method of claim 6, further comprising iteratively adding a plurality of nodes to the LLM-powered decision tree until a plurality of stopping criteria are met for a plurality of branches of the LLM-powered decision tree.

8. The method of claim 6, further comprising:
displaying the node in a user interface;
receiving a modification to the node via the user interface; and
modifying the LLM-powered decision tree based on the modification to the node.

9. The method of claim 8, further comprising:
executing the modified LLM-powered decision tree against a validation data set; and
displaying validation results metrics for the modified LLM-powered decision tree in the user interface.

10. The method of claim 8, further comprising: receiving a user confirmation of the node before adding a next node to the LLM-powered decision tree.

11. The method of claim 10, wherein the next node is configured to receive an input generated by the node.

12. The method of claim 8, wherein the modification is a rewording of the selected question associated with the node.

13. The method of claim 8, wherein the modification comprises supplying a text hint that is included in a context supplied to the LLM to generate the plurality of candidate questions.

14. The method of claim 8, wherein the modification is a deletion of the node.

15. A non-transitory computer-readable medium storing a data structure that represents a decision tree, the data structure comprising:
a root node;
a plurality of leaf nodes representing outputs of the decision tree selected based on traversing the decision tree by a processor of a computer system; and
a plurality of branch nodes connected between the root node and the plurality of leaf nodes, the branch nodes comprising an inference node having a prompt,
wherein evaluating the inference node during traversal of the decision tree comprises:
supplying the prompt and a first input data of the inference node to a large language model (LLM) to compute a first node evaluation result; and
selecting a first child node of a plurality of child nodes of the inference node based on the first node evaluation result and evaluating the first child node to continue the traversal of the decision tree.

16. The non-transitory computer-readable medium of claim 15, wherein the prompt of the inference node is generated automatically by a LLM prompted to generate prompts to split a training data set.

17. The non-transitory computer-readable medium of claim 15, wherein the plurality of branch nodes further comprises a code node comprising computer code, and wherein evaluating the code node during traversal of the decision tree comprises:
executing the computer code of the code node with a second input data of the code node as an argument to compute a second node evaluation result; and
selecting a second child node of a plurality of second child nodes of the code node based on the second node evaluation result and evaluating the second child node to continue the traversal of the decision tree.

18. The non-transitory computer-readable medium of claim 17, wherein the prompt of the code node is generated automatically by a LLM prompted to generate computer code to split a training data set.

19. The non-transitory computer-readable medium of claim 15, wherein a leaf node of the plurality of leaf nodes comprises a leaf prompt that, when supplied to a LLM together with an input to the leaf node, causes the LLM to generate a human-readable output of the decision tree.

20. The non-transitory computer-readable medium of claim 15, wherein a leaf node of the plurality of leaf nodes comprises computer code that, when executed by a processor with an input to the leaf node as an argument, causes the processor to compute an output of the decision tree.
